(19) United States
(12) Patent Application Publication
(10) Pub. No.: US 2016/0077685 A1
(43) Pub. Date: Mar. 17, 2016

(54) Operating System Virtual Desktop Techniques

(71) Applicant: Microsoft Technology Licensing, LLC, Redmond, WA (US)

(72) Inventors: Richard Fang, Bellevue, WA (US); Chaitanya Dev Sareen, Seattle, WA (US); Tsz Yan Wong, Seattle, WA (US); Michael A. Seibert, Redmond, WA (US); Richard W. Zarick, Seattle, WA (US); Jeremy Bowen, Renton, WA (US); Tyler J. Donahue, Bellevue, WA (US); Raju Jain, Woodinville, WA (US); Kyle T. Beck, Redmond, WA (US)

(73) Assignee: Microsoft Technology Licensing, LLC, Redmond, WA (US)

(21) Appl. No.: 14/486,981

(22) Filed: Sep. 15, 2014

(51) Int. Cl. G06F 3/0482; G06F 3/0484

(52) U.S. Cl. CPC G06F 3/0482; G06F 3/04842

(57) ABSTRACT

Operating system virtual desktop techniques are described. In one or more implementations, a plurality of virtual desktops are implemented by a single operating system of a computing device. Each of the virtual desktops includes a user interface that is configured to have an associated collection of windows that correspond to applications. Access to the plurality of virtual desktops is managed by the operating system that is navigable by a user to interact with associated collection of representations of application and windows corresponding to the applications by switching between the plurality of virtual desktops.

### BACKGROUND

Users may interact with an ever increasing amount of functionality using a computing device, such as a desktop computer, mobile computing device, game console, and so on. For example, a user may interact with a multitude of different applications to access a variety of different content a given day. Additionally, this interaction may be performed for a variety of different purposes, such as work-related purposes (e.g., interacting with a spreadsheet, composing a slideshow for a meeting, and so on) and even leisure-related purposes, such as to listen to music, view posts of a social network service, and so on.

However, conventional techniques employed by operating systems to support this interaction are limited to a single desktop. Therefore, an increase in an amount of applications and content that are provided for interaction with a user may cause a corresponding increase in clutter, inefficiency, and user frustration in locating application and content of interest. Consequently, users typically addressed the limitations of conventional techniques by opening and closing applications and content to address changes in desired interaction such that a user may locate applications and content of interest, which may be frustrating and hinder a user's interaction with the computing device.

### SUMMARY

Operating system virtual desktop techniques are described. In one or more implementations, a plurality of virtual desktops are implemented by a single operating system of a computing device. Each of the virtual desktops includes a user interface that is configured to have an associated collection of windows that correspond to applications. Access to the plurality of virtual desktops is managed by the operating system that is navigable by a user to interact with associated collection of windows corresponding to the applications by switching between the plurality of virtual desktops.

In one or more implementations, an apparatus includes a processing system and memory configured to maintain an operating system that is executable by the processing system to perform operations. The operations include output of an application launcher for display in a user interface. The application launcher includes representations of applications that are selectable for execution in a respective one of a plurality of virtual desktops of the operating system. Display of the representation of the applications as part of the application launcher includes use of a visual characteristic indicative of a corresponding one of the plurality of virtual desktops with which execution of a respective application is associated.

In one or more implementations, a system includes one or modules implemented at least partially in hardware. The one or more modules are configured to perform operations that include receiving a request by an operating system to access a particular one of a plurality of virtual desktops implemented by the operating system, obtaining data corresponding to the particular virtual desktop by the operating system, and configuring the particular virtual desktop by the operating system for access by a user, the particular virtual desktop implemented by the operating system along with at least one other virtual desktop.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to perform operating system virtual desktop techniques described herein.

FIG. 2 depicts an example implementation of a system that includes a desktop manager module and examples of virtual desktops of FIG. 1.

FIG. 3 depicts an example implementation showing an all-up view that is usable to navigate between virtual desktops of an operating system of a computing device.

FIG. 4 depicts an example implementation showing a preview that is usable to navigate between virtual desktops of an operating system of a computing device.

FIG. 5 depicts an example implementation in which a menu is output having options to set taskbar and navigation properties for virtual desktops.

FIG. 6 depicts an example implementation showing global differentiation of representations in an application launcher to indicate correspondence with a respective one of a plurality of virtual desktops.

FIG. 7 depicts an example implementation in which a taskbar of FIG. 6 supports a preview of virtual desktops.

FIG. 8 depicts an example implementation showing an application launcher configured as a taskbar and having a filtered collection of representations based on association with virtual desktops.

FIG. 9 depicts an example implementation showing an application launcher configured as a taskbar and having a filtered collection of representations based on association with virtual desktops as well as including representations of applications specified by a user.

FIG. 10 depicts an example implementation showing another application launcher configured as a taskbar and having a global collection of representations and indicating association with respective virtual desktops.

FIG. 11 depicts an example implementation showing additional examples of previews of virtual desktops.

FIG. 12 depicts an example implementation showing output of a keyboard and context menu.

FIG. 13 depicts an example implementation showing output of a menu in conjunction with a representation of a virtual desktop included in a preview

FIG. 14 depicts an example implementation showing examples of previews of representations of virtual desktops output responsive to hover inputs.

FIG. 15 depicts an example implementation of navigation between virtual desktops of an operating system.

FIG. 16 is an illustration of an example implementation of an all-up user interface view that employs wings that support navigation between virtual desktops.

FIG. 17 depicts an example implementation showing menus usable to specify how applications are associated with virtual desktops.

FIG. 18 depicts an example implementation of virtual desktops using a plurality of display devices.

FIG. 19 depicts another example implementation of virtual desktops using a plurality of display devices.

FIG. 20 depicts yet another example implementation of virtual desktops using a plurality of display devices.

FIG. 21 depicts a further example implementation of virtual desktops using a plurality of display devices.

FIG. 22 depicts an example implementation of an option that is selectable by a user to show a virtual desktop.

FIG. 23 is a flow diagram depicting a procedure in an example implementation in which a plurality of virtual desktops are implemented by a single operating system.

FIG. 24 is a flow diagram depicting a procedure in an example implementation in which data is obtained to implement a virtual desktop by an operating system.

FIG. 25 illustrates an example system including various components of an example device that can be implemented as any type of computing device as described with reference to FIGS. 1-24 to implement embodiments of the techniques described herein.

### DETAILED DESCRIPTION

Overview

As the functionality made available via computing devices increases, so too does the difficulty in accessing this functionality using conventional techniques. For example, a user may access a variety of applications, each of which may include one or more windows, have representations that are selectable to launch execution of the application and navigate to the application when executed, and may have a variety of different content, with which, a user interacts using the application. Accordingly, this functionality may quickly clutter a single desktop that is provided under conventional techniques to support user interaction. Although techniques have been developed to address these limitations, these techniques are limited to expanding a size of a single desktop, which thus merely serves to expand an amount of area that may experience this clutter and increase user inefficiency in locating content, applications, and windows of interest.

Operating system virtual desktop techniques are described. In one or more implementations, a single operating system is configured to support a plurality of virtual desktops. Each of the virtual desktops may have associated therewith representations of applications, a background, application launcher (e.g., taskbar, start menu, start screen), notification system (e.g., device status, date, clock), and so forth such that a user may configure the virtual desktops for different usage scenarios.

A user, for instance, may configure a work-related virtual desktop and include representations of applications and content (e.g., spreadsheets, documents, slideshows), configuration of a taskbar, start menu, background, and so forth that are tailored for work-related activities. Likewise, the user may configure a leisure-related virtual desktop that includes representations of applications and content (e.g., social network service links and personal photos), configuration of a taskbar, start menu, background, and so forth that are tailored for leisure-related activities. The user may then interact with the operating system to switch virtual desktops to access these configurations. In this way, a user may quickly access different usage scenarios supported by the operating system with increased efficiency over conventional techniques, further discussion of this and other examples may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

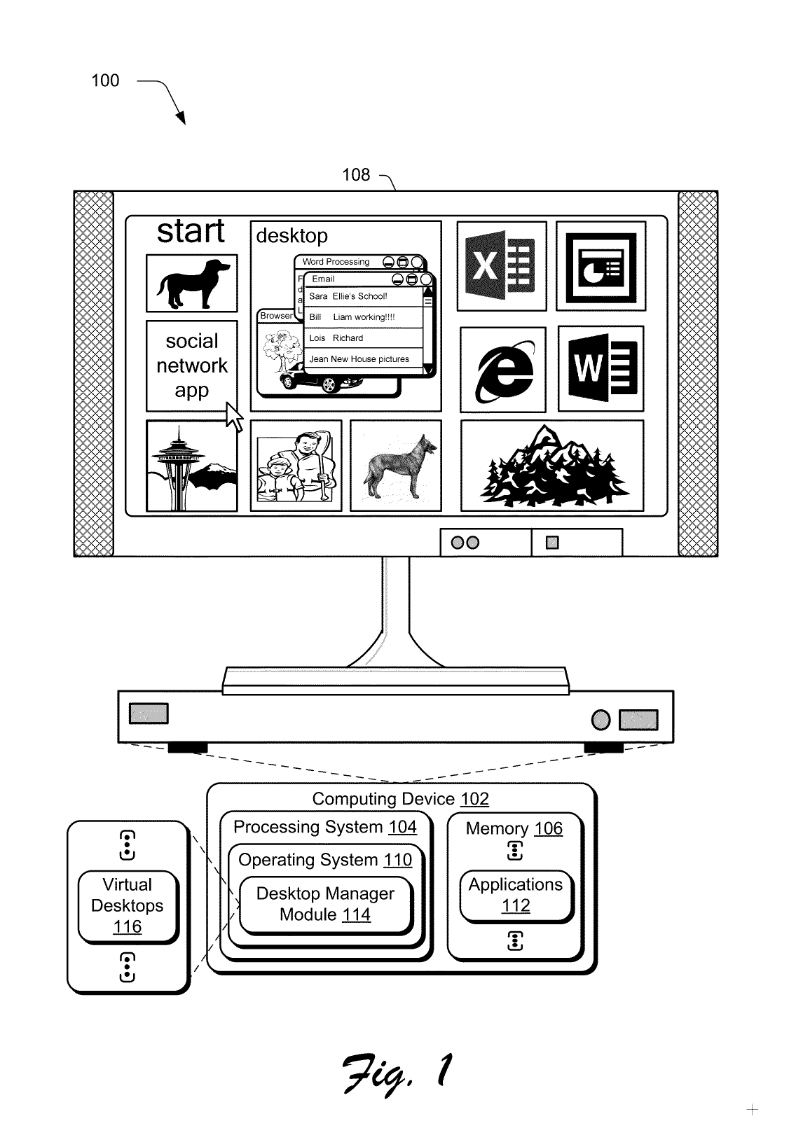

FIG. 1 is an illustration of an environment 100 in an example implementation that is operable to employ the data sharing session techniques described herein. The illustrated environment 100 includes a computing device 102. The computing device 102 may be configured in a variety of ways. For example, the computing device 102 may be configured as a conventional desktop computer, a mobile station, an entertainment appliance, a mobile computing device having a housing configured in accordance with a handheld configuration (e.g., a mobile phone or tablet), a set-top box communicatively coupled to a display device, a wireless phone, a game console, and so forth.

Thus, the computing device 102 may range from full resource devices with substantial memory and processor resources (e.g., personal computers, game consoles) to low-resource devices with limited memory and/or processing resources (e.g., traditional set-top boxes, hand-held game consoles). Additionally, although an instance of a single computing devices 102 are shown, the computing device 102 may be representative of a plurality of different devices, such as multiple servers utilized by a business to perform operations such as by a web service, a remote control and set-top box combination, an image capture device and a game console configured to capture gestures, and so on.

The computing device 102 is illustrated as including a processing system 104, an example of a computer-readable storage medium illustrated as memory 106, and a display device 108. The processing system 104 is representative of functionality to perform operations through execution of instructions stored in the memory 106. Although illustrated separately, functionality of these components may be further divided, combined (e.g., on an application specific integrated circuit), and so forth.

The computing device 102 is further illustrated as including an operating system 110. The operating system 110 is configured to abstract underlying functionality of the computing device 102 to applications 112 that are executable on the computing device 102. For example, the operating system 110 may abstract processing system 104, memory 106, network, and/or display device 108 functionality of the computing device 102 such that the applications 112 may be written without knowing “how” this underlying functionality is implemented. The application 112, for instance, may provide data to the operating system 110 to be decoded, rendered and displayed by the display device 108 without understanding how this rendering will be performed. The operating system 110 may also represent a variety of other functionality, such as to manage a file system and user interface that is navigable by a user of the computing device 102.

An example of the abstracted functionality of the operating system 110 is represented as a desktop manager module 114. The desktop manager module 114 is representative of functionality of the operating system 110 to manage one or more virtual desktops 116. The virtual desktops 116, for instance, may be accessible via a single user login, associated with a single user profile, and so on such that switching may be performed between the virtual desktops 116 without switching user accounts or logging and re-logging in and out for access. Each of the virtual desktops 116 may be associated with corresponding functionality found in a desktop that may be customized by a user to provide desired functionality, further discussion of which may be found in relation to the following description and is shown in a corresponding figure.

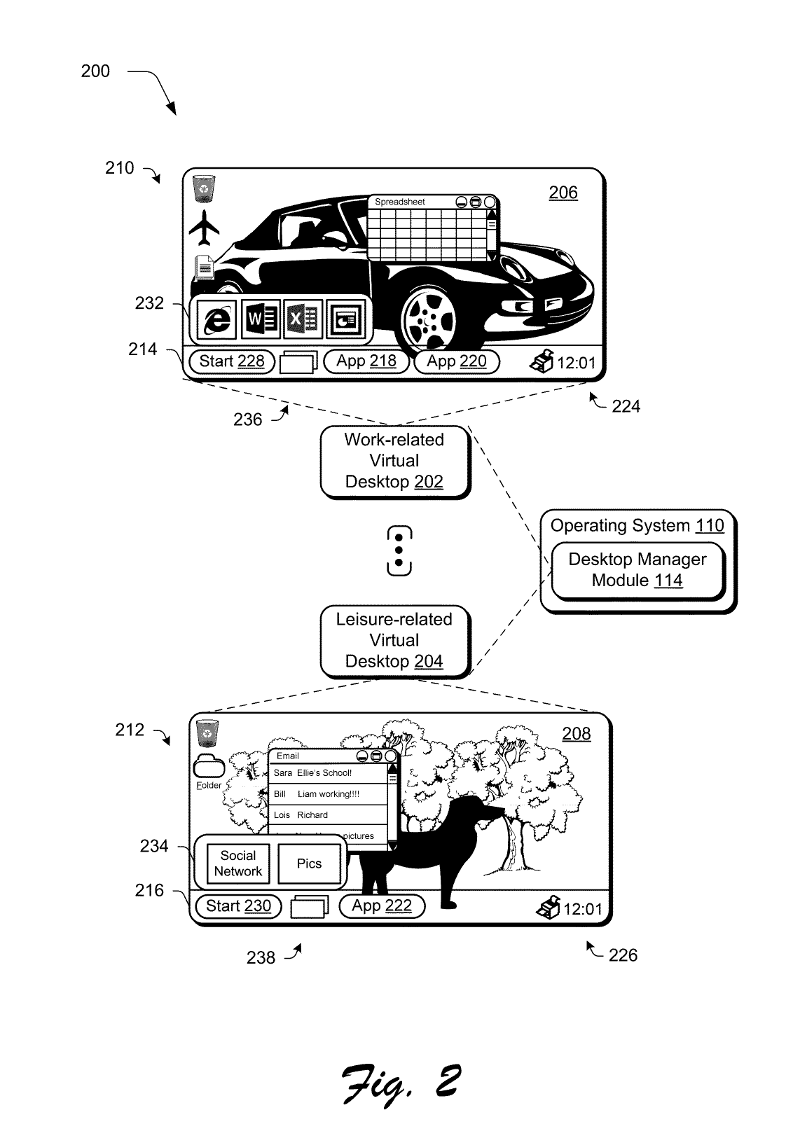

FIG. 2 depicts an example implementation 200 of a system that includes the desktop manager module 114 and examples of virtual desktops 116 of FIG. 1. The desktop manager module 114 is configured to manage a plurality of virtual desktops 116, illustrated examples of which include a work-related virtual desktop 202 and a leisure-related virtual desktop 204. The work-related and leisure-related virtual desktops 202, 204 may be configured to include corresponding instances of functionality that may be made available via a desktop that may be customized differently by a user for each of the virtual desktops.

The work-related and leisure-related virtual desktops 202, 204, for instance, may be configured as a root level of a hierarchical file structure, e.g., each of the other levels are “beneath” the root level in the hierarchy within those virtual desktops. The representations shown in the illustrated example are selectable to launch a corresponding one of the applications 114 of FIG. 1 for execution on the computing device 102. In this way, a user may readily navigate through a file structure and initiate execution of applications 114 of interest.

The work-related and leisure-related virtual desktops 202, 204 are also illustrated as including respective backgrounds 206, 208 having respective images of a car and a forest scene with a dog in this example. The backgrounds 206, 208 are indicative of areas of a user interface with which a user may interact with the operating system 110 and thus it should be readily apparent that this area may also be utilized without inclusion of images.

The backgrounds 206, 208 of the virtual desktops 202, 204 are configured to include representations 210, 212 of functionality and user interfaces (e.g., windows) that are customizable and accessible by a user via the backgrounds 206, 208, such recycle bins, applications, folders, content, and so forth. For example, a user may drag documents or applications to the recycle bins to remove them, may select (e.g., “click”) representations of content or applications to launch execution and/or navigate to a user interface corresponding to the content and applications (e.g., windows), and so on. Thus, a user may specify representations for inclusion “on” the backgrounds 206, 208 as desired, such as to include representations of functionality that is work related in the work-related virtual desktop 202 and representations of functionality that is leisure related in the leisure-related virtual desktop 204.

The work-related and leisure-related virtual desktops 202, 204 also each include application launchers that are configured to include representations of applications, content, and other functionality that is selectable to initiate execution of and/or navigate to the represented applications, content, and other functionality. The backgrounds 206, 208 described above, for instance, are one example of an application launcher. Other examples are also contemplated and shown in the figure.

Application launchers, for instance, may be configured as taskbars 214, 216. Taskbars 214, 216 are configured as bars in this example that are displayed proximal to an edge of a graphical user interface of the backgrounds 206, 208 that may be utilized to launch, monitor, and navigate to applications and content. The taskbars 214, 216, for instance, may be configured for minimization when not in use and accessed by placing a cursor or touch input near the edge (e.g., such as a swipe in a touch example) to cause display of representations of applications. In this example, the taskbars 214, 216 are configured such that each taskbar 214, 216 includes representations of applications 112 that are executed within a context of the respective virtual desktop, although other examples are also contemplated.

Representations of applications 218, 220, for instance, are included in the taskbar 214 of the work-related virtual desktop 202 while a representation of a single application 222 is included in the taskbar 216 of the leisure-related virtual desktop 204. The representations may be included in a variety of ways, such as by being specified by a user (e.g., “pinning” to the taskbars 214, 216), automatically upon execution of respective applications by the computing device 102, and so forth. In this example, the represented applications may be different and thus may be considered “localized” to the respective virtual desktops. Other examples are also contemplated, such as a global taskbar, further description of which may be found in relation to a discussion of FIG. 5.

The taskbars 214, 216 are also illustrated as including respective notification areas 224, 226, e.g., also known as system trays, status areas, and so forth. The notification areas 224, 226 may include notifications for computing device 102, peripheral device (e.g., a printer as illustrated) and application features that do not have a presence elsewhere on the virtual desktops in this example as well as a time, date, volume, and so forth. Selection of the notifications of the notification areas 224, 226 (e.g., a hover, “click,” touch input, and so on) may also cause navigation to corresponding functionality, such as to a printer status. For example, a printer driver of the computing device 102 may include a notifications of the printer in the notification areas 224, 226 as illustrated to indicate that a printing job is underway. Other examples are also contemplated without departing form the spirit and scope thereof.

The taskbars 214, 216 are also illustrated as including representations that are selectable to cause output of additional application launchers, such as start 228, 230 representations that are selectable to output a start menus 232, 234 as illustrated. The start menus 232, 234 may also be configured as a start screen that is modal and consumes an available display area of a display device 108. The start menus 232, 234, for instance, may include representations of applications or other content that is specified by a user for inclusion in the start menus 232, 234 for quick access, e.g., by “pinning” the applications 114 as previously described, a drag-and-drop, and so forth.

In this way, a user may specify applications 112 for immediate access by pinning the applications to a taskbar 214, 216 and specify applications for ready but not immediate access through inclusion in the start menu 232, 234. Other examples are also contemplated, such as an “alt-tab” menu that is caused to be output responsive to that or another key combination that includes representations of applications that are currently available for execution, e.g., actively executed, in a sleep state to conserve computing device 102 resources but loaded in memory 106 for execution by the processing system 104, and so forth.

The virtual desktops 116 may also include functionality to enable a user to switch between the virtual desktops 116. The desktop manager module 114, for instance, may be configured to recognize gestures, spoken utterances, key combinations, and so on to cause the desktop manager module 114 to switch from one of the virtual desktops 116 to another. As illustrated in FIG. 2, for instance, options 236, 238 may be included in the taskbars 214, 216 or elsewhere that are selectable to navigate between the work-related virtual desktop 202 and the leisure-related virtual desktop 204. In this way, a user may readily switch between the different user contexts provided by the virtual desktops. Other examples are also contemplated, further discussion of which may be found in the following and is shown beginning in relation to FIG. 5.

In one or more implementations, a virtual desktop 116 may implement a security barrier to prevent data from passing between the virtual desktop 116 and another virtual desktop. This may also be utilized to limit permissions and user access to data within the virtual desktops differently. For example, applications and other functionality may be executed within a sandbox by the operating system 110. This may be utilized to support a variety of different functionality, such as for a company to specify a work-related virtual desktop having limited permissions and data sharing including limitation of applications that are work related to execution within this virtual desktop while permitting users to create and utilize other virtual desktops for other purposes.

FIG. 3 depicts an example implementation 300 showing an all-up view that is usable to navigate between virtual desktops of an operating system of a computing device. In this example, selection of an option 302 to navigate between virtual desktops causes output of representations 304, 306 of virtual desktops that are currently available to a user. The representations 304, 306 are selectable to navigate to corresponding virtual desktops. As illustrated, the representations 304, 306 may be configured to provide a preview of the corresponding virtual desktops such that a user may readily identify functionality available via the desktops. In one or more implementations, if an application is in a full-screen view within a virtual desktop, a window of the application is automatically reduced to show at least a portion of an image of a background of the virtual desktop to provide a visual characteristic that is identifiable by a user as corresponding with that virtual desktop for identification of the desktop.

Hovering momentarily on the representations 304, 306 will center that virtual desktop in this view. This allows a user to look for a window on another virtual desktop without having to leave the all-up view. If the user hits escape the user may will return to the virtual desktop from which they originally entered the all-up view. Selection of this option 302 also includes output of a feature 308 to initiate creation of an additional virtual desktop to be added to existing virtual desktops for access by a user. A user may initiate creation in a variety of ways, such as by dragging a window to this option 302 to cause creation of a virtual desktop that includes the window.

FIG. 4 depicts an example implementation 400 showing a preview that is usable to navigate between virtual desktops of an operating system of a computing device. In this example, a user “hovers,” e.g., displays a cursor or touch input proximal to, the option 302 to navigate between virtual desktops. This causes representations 402, 404 of the virtual desktops to be output as previews as proximal to the taskbar 406. An option 406 is also included as above to initiate creation of another virtual desktop.

At initial login, a user may start out with a single virtual desktop or other saved virtual desktops. During the user session additional virtual desktops may be created as well as deleted as previously described. However, at least one virtual desktop is made available to the user at all times. Newly created windows may be associated with the virtual desktop from which it was launched, even if an event has taken the user to a different virtual desktop. In another example, new windows may appear on a current virtual desktop.

Windows that are designated to one virtual desktop by default may be referred to as switch target windows. Switch target windows roughly maps to the windows that are represented typically represented in user interfaces as being available for current execution, e.g., in an “ALT+TAB” view.

Owned windows may inherit the virtual desktop association of their owner. Other non-switch target windows (e.g., modeless toast notifications and so on) may be by default associated with each of the virtual desktops. In this way, a notification associated with execution of an application in one virtual desktop may be viewed in other virtual desktops. Other examples are also contemplated, such as to limit notifications to corresponding virtual desktops.

Virtual desktops may be configured to be limited to display of windows associated with applications executing in a context of that virtual desktop. Other windows not associated with the current virtual desktop are not on that virtual desktop in this example. The desktop manager module 114 may also support association of windows with multiple virtual desktops. The association may be specified for an application 112 that has switch target windows to the current virtual desktop or all virtual desktops, e.g., current and future.

When a new virtual desktop is created, switch target windows are not shown in the new virtual desktop unless a user has designated it to show on all virtual desktops. Non switch target windows may be shown, however. Further, any virtual desktop may be closed at any time, and thus users are not restricted to closing virtual desktops in the reverse order in which the virtual desktops were created. However the last remaining virtual desktop cannot be closed as previously described such that there is always one virtual desktop in the user login session to support user interaction with the operating system 110.

When a virtual desktop 116 is closed any switch target windows that are not designated to show on each of the virtual desktops is disassociated with the closed virtual desktop and re-associated with the virtual desktop that comes before it. In the event no virtual desktops 116 come before the closed virtual desktop 116, these windows are re-associated with the virtual desktop 116 that comes after it. The re-associated windows appear on top (z-order) of the existing windows in the virtual desktop 116.

In one or more implementations, new windows that are launched by the user (e.g. start menu, taskbar, or other application launcher) or launched programmatically by the application are associated with the current virtual desktop 116. In the event the launch took place from an immersive experience (e.g. a start screen as shown in FIG. 1) the new window is associated with the most recent virtual desktop.

When closing and minimizing windows, a foreground may be automatically shifted to the last window with focus on the current virtual desktop 116. This prevents moving a user unexpectedly to a different virtual desktop 116 after closing or minimizing a window. When switching virtual desktops 116, the same fallback foreground logic is used as if a window with foreground had been closed. In another example, owned windows may send foreground to their owner in preference to other windows, e.g., the foreground may go to another window on the current virtual desktop.

When launching an application 112, the application 112 may choose to set a foreground to a window in a different virtual desktop 116. For example, the application 112 may switch to the window in the other virtual desktop, may bring the window to the current virtual desktop, and so on.

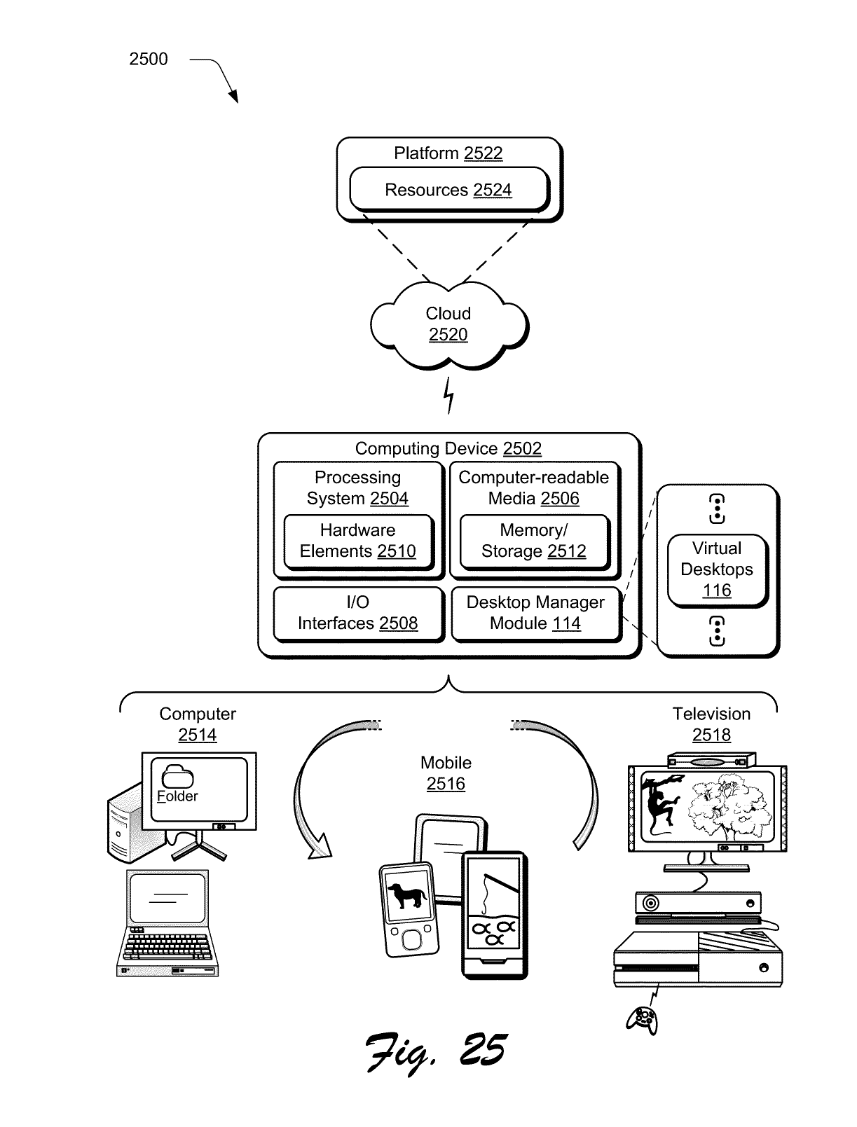

Virtual desktops 116 may also automatically persist across a user session, e.g. log off or reboot. After creating a virtual desktop 116, for instance, it is up to the user to close it. Virtual desktop backgrounds and labels may also persist across a user session and if a user set an application 112 to be available across each of the virtual desktops 116, this choice may be respected across user login sessions, further discussion of which may be found in relation to FIG. 24.

FIG. 5 depicts an example implementation in which a menu 500 is output having options to set taskbar and navigation properties for virtual desktops 116. Virtual desktop settings may act as an additional filter on top of existing taskbar settings. A window, for instance, may be represented when it meets existing requirements and a new virtual desktop setting. In other words, it's the intersection of windows that meet the existing settings with the windows that meet the virtual desktop settings.

As shown in the menu 500 in FIG. 5, for instance, an option 502 is provided to specify how taskbar buttons are shown, such as on all virtual desktop or virtual desktops that include the open window. An option 504 is also provided to show taskbar buttons where the window is open or on all virtual desktops. An additional option 506 is also included regarding buttons on other taskbars, such as whether to always combine and hide labels indicative of the virtual desktop, visually differentiate the buttons based a respective desktop through use of a visual characteristic, or restrict from inclusion on other virtual desktops.

FIG. 6 depicts an example implementation 600 showing global differentiation of representations in an application launcher to indicate correspondence with a respective one of a plurality of virtual desktops. The desktop manager module 114 may include an option such that an application launcher, such as a taskbar, start menu, or so on, includes representations of each of the applications being executed on the computing device 102, regardless of which virtual desktop this execution is associated with. In other words, representations of applications being executed in a context of another virtual desktop 116 may be represented in an application launcher of a current virtual desktop 116.

To increase efficiency in finding windows on the current virtual desktop 116, the application launcher includes visual characteristics that are indicative of an association of the represented application with a corresponding virtual desktop 116. The visual characteristics may be utilized in a variety of ways, such as through use of common colors, shading, inclusion of part of a corresponding image from a background of the virtual desktop 116, and so forth.

As shown in FIG. 6, for instance, a taskbar 602 includes representations of windows of applications on a current virtual desktop 116 plus specified windows of applications from other virtual desktops 116 using a box. When another virtual desktop is created as shown by taskbar 604, windows on other virtual desktops 116 include a bar with a corresponding representation that indicates correspondence with a respective virtual desktop 116. After usage of the newly created virtual desktop as shown in taskbar 606, applications that have windows that in a current virtual desktop and are copied on other virtual desktops may receive both treatments.

FIG. 7 depicts an example implementation 700 in which a taskbar of FIG. 6 support a preview of virtual desktops. In this example, a user has “hovered” a cursor proximal to a representation in the taskbar 606, although other inputs are also contemplated. In response, the desktop manager module 114 causes output of a preview 702.

The preview 702 includes a grouping 704 of representations of a current virtual desktop 116 being accessed by a user and a grouping 706 of representations of applications associated with other virtual desktops 116, separated by a divider in this example. Other visual characteristics to indicate association between represented applications and virtual desktops are also contemplated, such as colors, shading, inclusion of portions of corresponding background images, and so on. In this way, the preview 702 may also be utilized to visually differentiate the representations based on association with respective virtual desktops and thus may aid a user in efficiently selecting and navigating between the virtual desktops through use of the preview 702.

In another example, a UI language discussed in relation to FIG. 6 may be extended for use in the previous 702. For instance, a bar may be color coded, progress of an application in processing a task may be indicated, an extended user interface could indicated by a bar based on a color or theme of a corresponding virtual desktop, and so on.

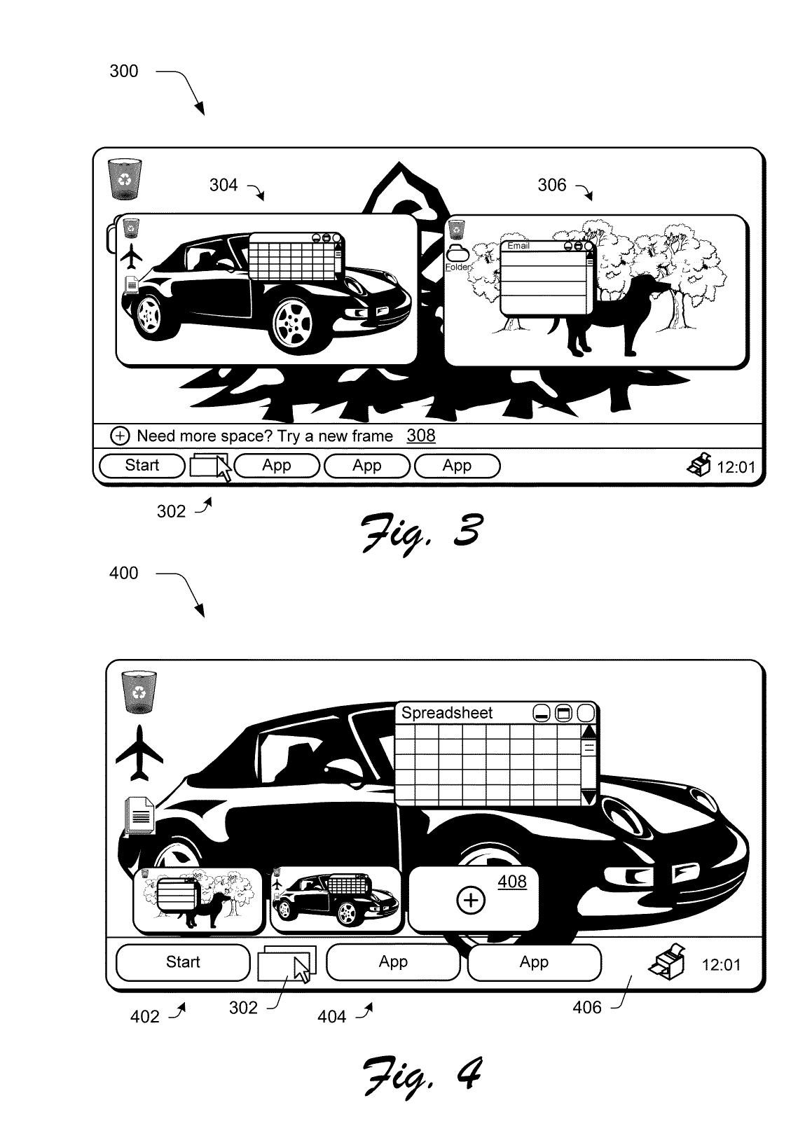

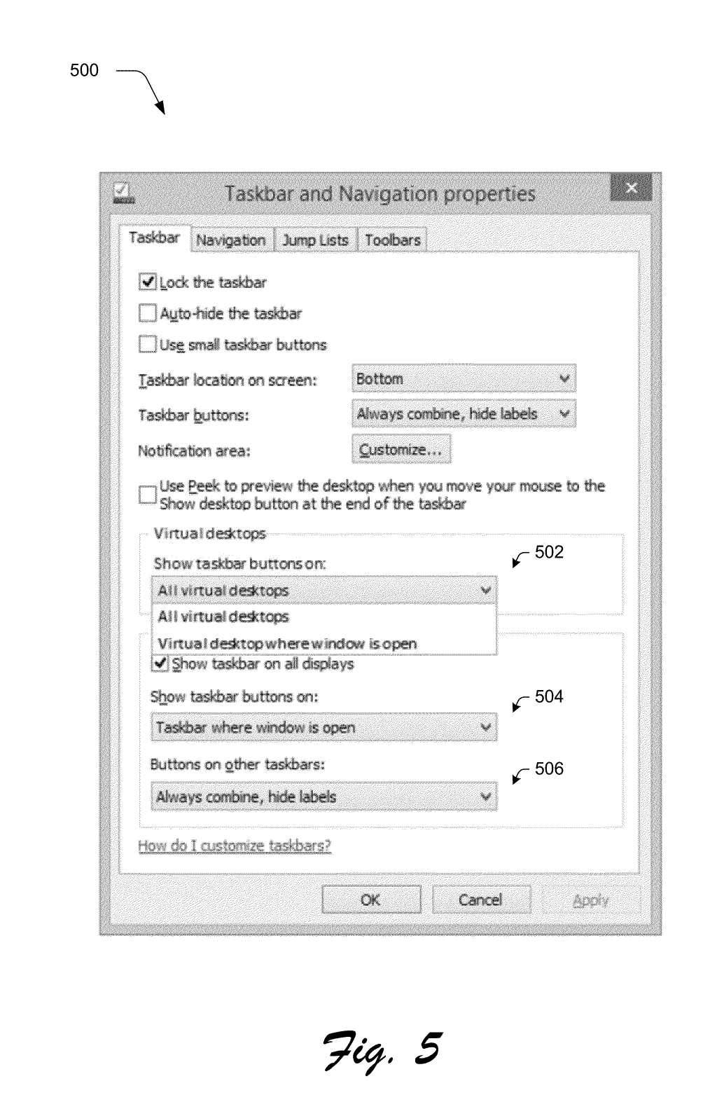

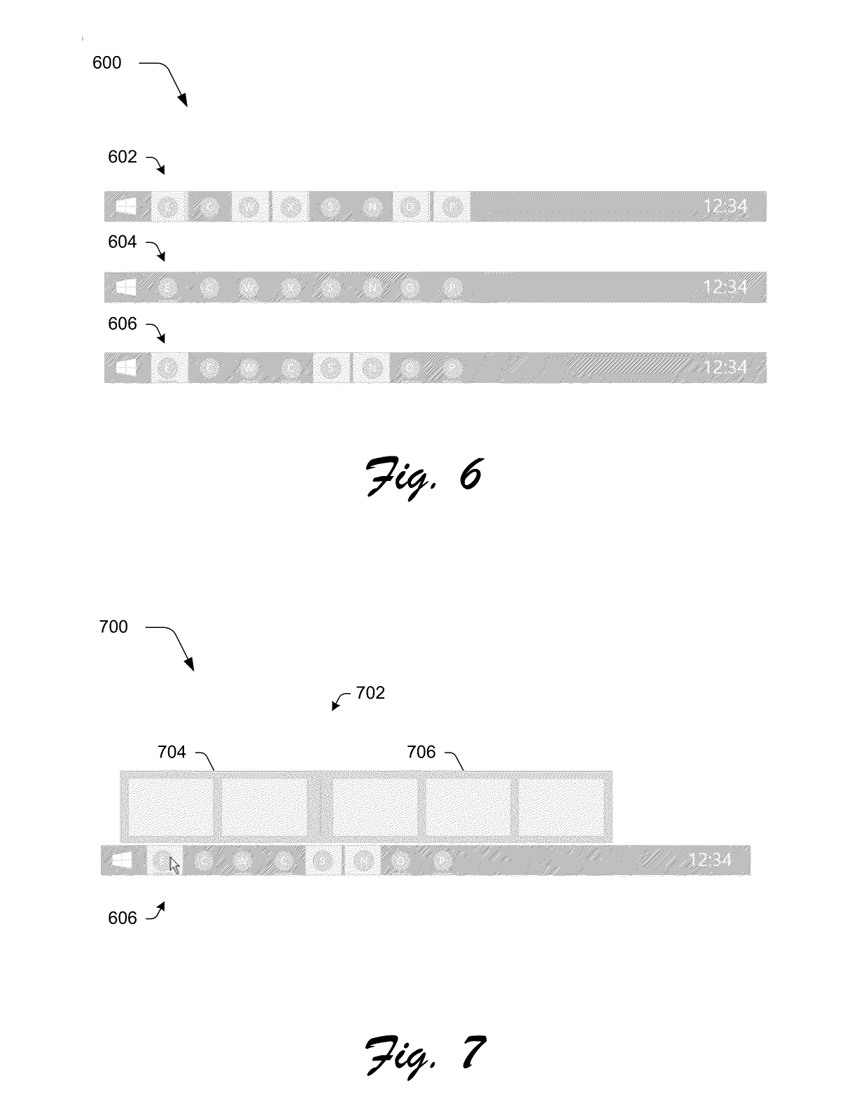

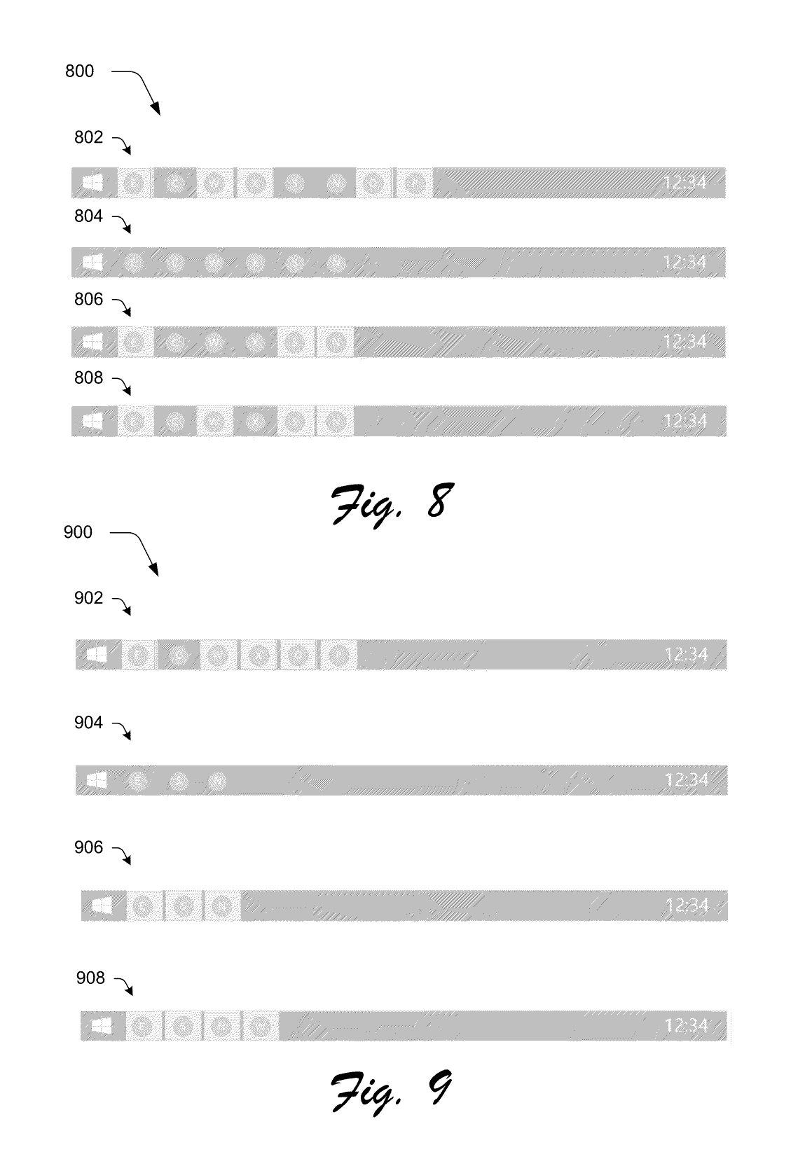

FIG. 8 depicts an example implementation 800 showing an application launcher configured as a taskbar and having a filtered collection of representations based on association with virtual desktops. In this example, an application launcher such as a taskbar is configured to include representations of applications from a current virtual desktop and applications that “need attention” and that have requested inclusion in the taskbar, e.g., as part of a notification requesting user interaction and so forth.

Taskbar 802, for instance, illustrates an example in a context of a single virtual desktop 116 as before. Once a new virtual desktop is created, a taskbar 804 may assume a configuration as before which may change to taskbar 806 after usage to indicate correspondence of the applications that need attention to corresponding other virtual desktops through a visual characteristic, e.g., the boxes, bars, and so forth. Applications selected for inclusion from other virtual desktops may also be included as shown in taskbar 808.

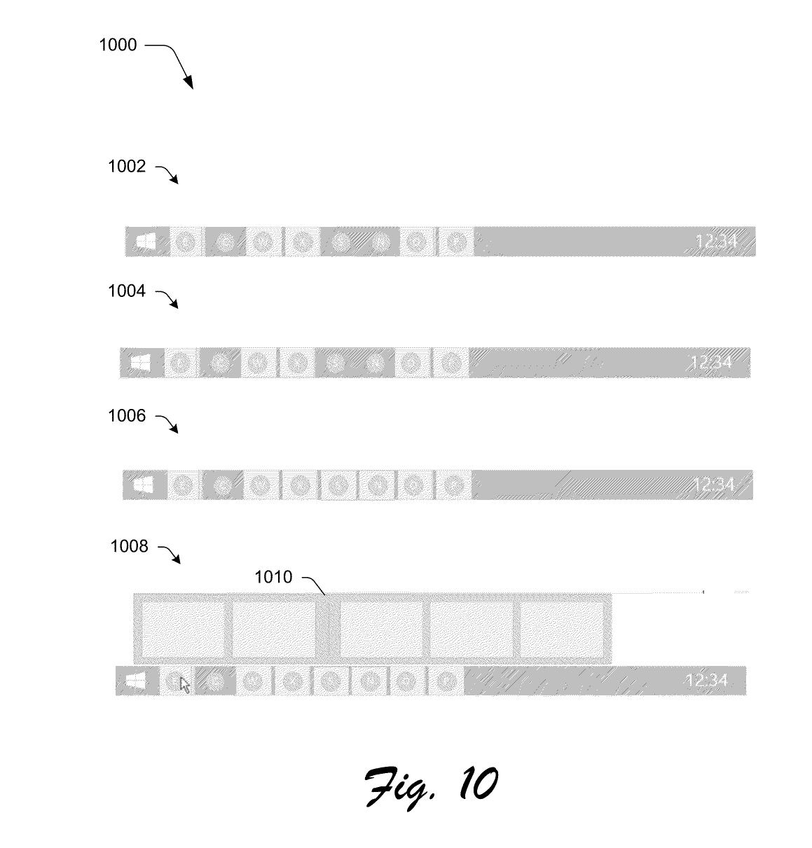

FIG. 9 depicts an example implementation 900 showing an application launcher configured as a taskbar and having a filtered collection of representations based on association with virtual desktops as well as including representations of applications specified by a user. In this example, an application launcher such as a taskbar is configured to include representations of applications from a current virtual desktop and applications that have been selected by a user for inclusion in the taskbar, e.g., “pinned” to the taskbar.

Taskbar 902, for instance, illustrates an example in a context of a single virtual desktop 116 as before. Once a new virtual desktop is created, a taskbar 904 may assume a configuration as before which may change to taskbar 906 after usage to indicate correspondence of the user-specified applications to corresponding other virtual desktops through a visual characteristic, e.g., the boxes, bars, and so forth. Applications selected for inclusion from other virtual desktops may also be included as shown in taskbar 808.

Because the taskbar is filtered it is possible a window in another virtual desktop needs attention (e.g., “needy”) while it's not represented as running on the taskbar. If the application that needs attention is pinned to the taskbar that icon representation may inherit the “needs attention” state. If the application is not pinned to the taskbar, the representation of the application may be appended on the taskbar and indicate the state of “needs attention.” Only the window of that application that needs attention is represented from the representation as opposed to each of the windows in this example. When clicking on the representation or extended UI the user is transitioned to the corresponding virtual desktop with focus on the window that needs attention.

FIG. 10 depicts an example implementation 1000 showing another application launcher configured as a taskbar and having a global collection of representations and indicating association with respective virtual desktops. Taskbar 1002 illustrates an example in a context of a single virtual desktop 116. Once a new virtual desktop is created, a taskbar 1004 may assume a configuration as before which may change to taskbar 1006 after usage to indicate correspondence of the user-specified applications to corresponding other virtual desktops through a visual characteristic, e.g., the boxes, bars, and so forth.

Taskbar 1008 is illustrated along with a preview 1010 of representations of other virtual desktops as described in relation to FIGS. 3 and 4. Thus, the preview 1010 may act as an extended user interface on hover of a cursor over a representation in the taskbar that also shows a differential visual for windows that are opened in the current virtual desktop versus elsewhere in other virtual desktops.

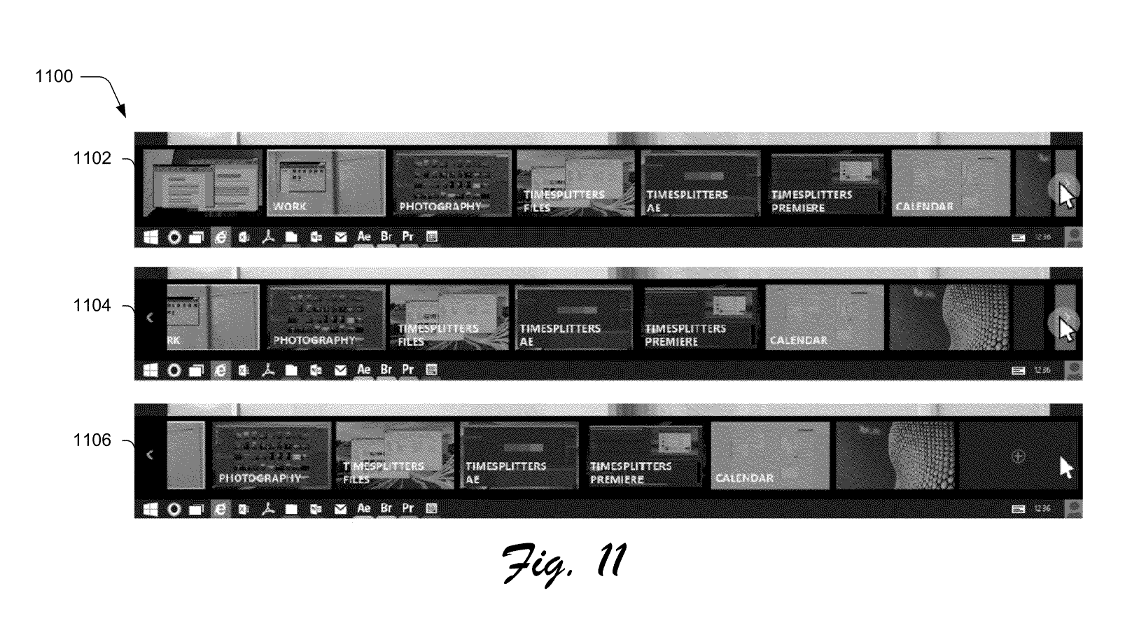

FIG. 11 depicts an example implementation 1100 showing additional examples of previews 1102, 1104, 1106 of virtual desktops. In this example, the representations of the virtual desktops are configured as thumbnails in the previews 1102, 1104, 1106. The thumbnails may be dragged and moved to rearrange their position relative to other thumbnails in the previews. This may also be accompanied by an animation such that once the drag starts, the original slot of the represented virtual desktop may collapse, extra space is created between the virtual desktops to indicate where it will go once released, hovering over partially visible virtual desktops may cause scrolling, and once released representations of other virtual desktops are moved such that the selected representation falls into place. It should be readily apparent that other examples of animations are also contemplated.

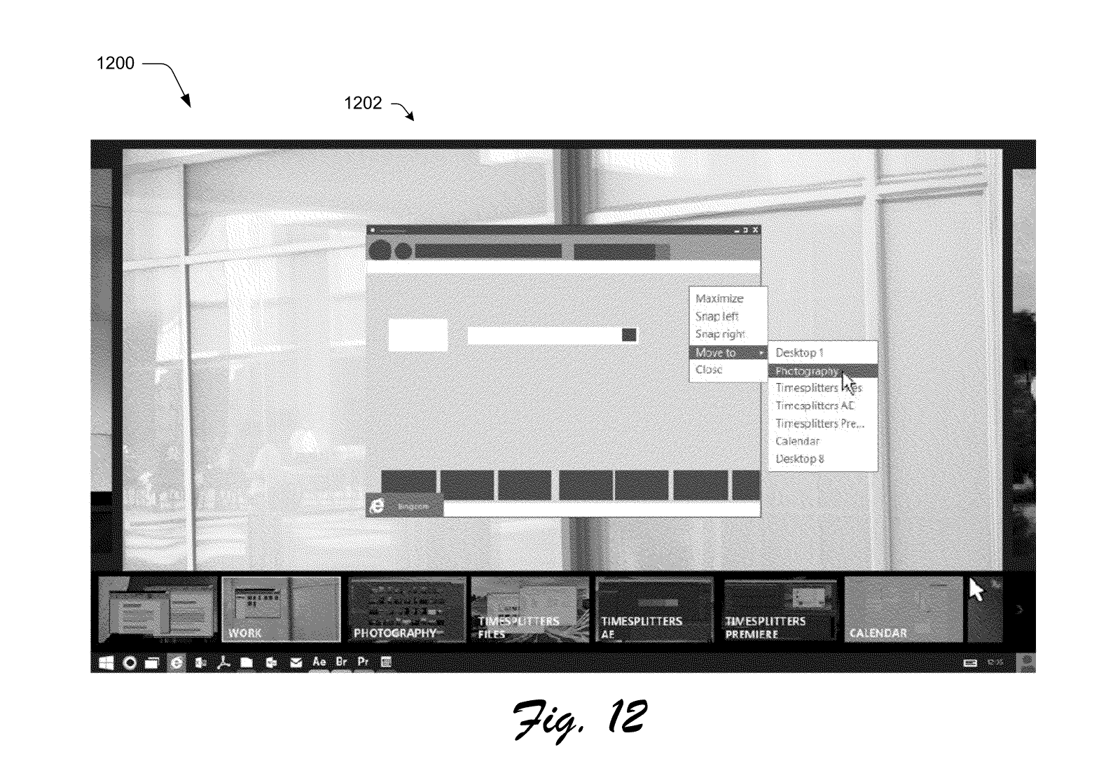

FIG. 12 depicts an example implementation 1200 showing output of a keyboard and context menu 1202. The user interface in this example includes and “all up” view as previously described. From this view, keyboard users may tab or use arrow keys to get access to the ‘+’ button and virtual desktop thumbnails. Virtual desktop objects are at the end of the tab order in all-up view, or the user can use a key combination (e.g., “SHIFT-TAB”) to access it.

From the last row, “DOWN_ARROW” selects the virtual desktop items. Or from the very last item of the grid of windows, “RIGHT_ARROW” (or “LEFT_ARROW” on RTL) selects the virtual desktop items. As illustrated, a right-click menu from the menu 1202 causes exposure of a “Move to” option when there are at least two virtual desktops and the window is not already directly available via each of the virtual desktops. The cascading level allows the user to choose which virtual desktop is to receive the window. Accordingly, the current virtual desktop is not present in the list of virtual desktops as it is the source. Once committed, the menu 1202 reflows as if the window has been closed.

FIG. 13 depicts an example implementation 1300 showing output of a menu in conjunction with a representation of a virtual desktop included in a preview 1302. In this example, a user has caused output of a menu 1304 through interaction with a representation of a virtual desktop, e.g., by “right clicking” the representation. The menu 1304 includes a variety of commands which include reorder, close all windows, close desktop, and rename.

After selecting reorder from the context menu, for instance, that virtual desktop thumbnail may be actively selected. Using navigation keys such as right arrow or left arrow may cause movement of the representation (e.g., the virtual desktop thumbnail) in the order. Hitting “enter” may commit that reorder change whereas “ESC” returns the preview 1302 to its original position.

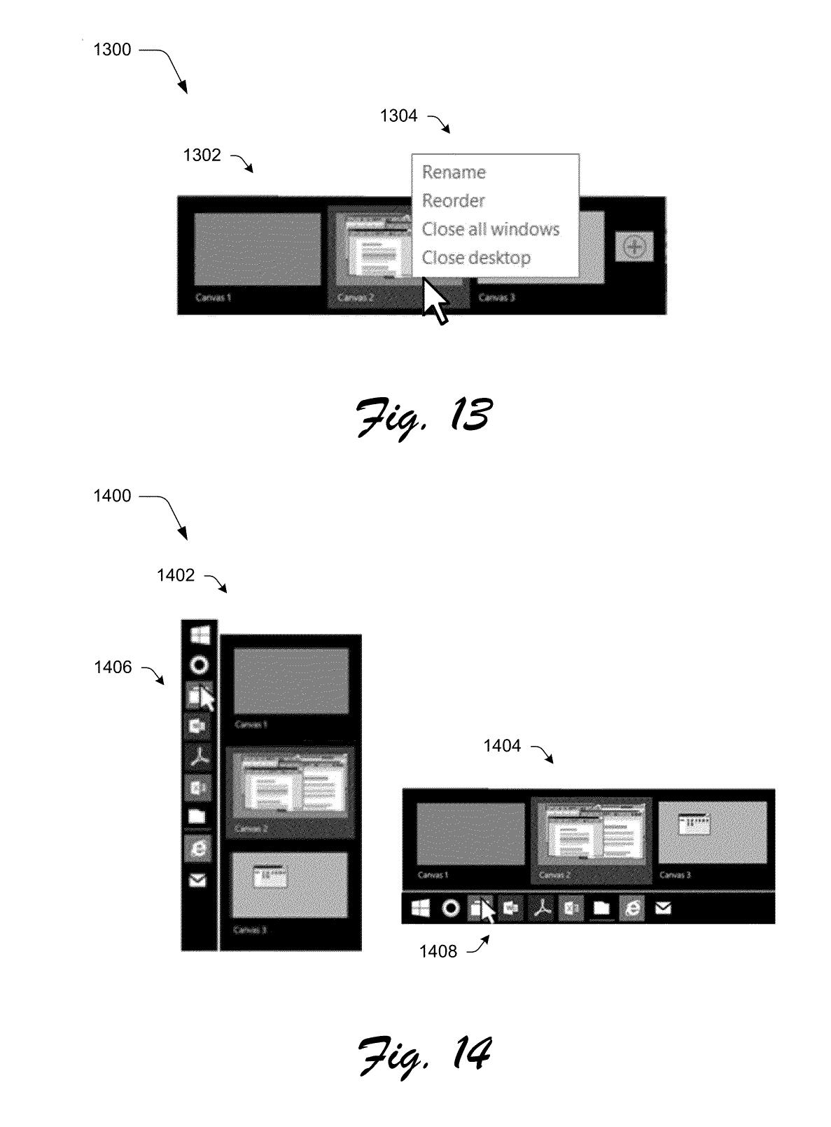

FIG. 14 depicts an example implementation 1400 showing examples of previews 1402, 1404 of representations of virtual desktops output responsive to hover inputs. When more than one virtual desktop is available to a user by the desktop manager module 114 of the operating system 110, hovering of the cursor over options 1406, 208 to navigate to different virtual desktops invokes the previews 1402, 1404 including representations of the virtual desktops that are available.

A user may further hover over one of the representations to get a live preview of the corresponding virtual desktop as well as reveal a close button that may be presented proximal to the respective representation. As illustrated, the previews 1402, 1404 may assume a variety of configurations, such as vertical and horizontal as well as other configurations such as a grid, radial, and so forth. Other examples are also contemplated, e.g., in which an actual switch to a corresponding virtual desktop is performed.

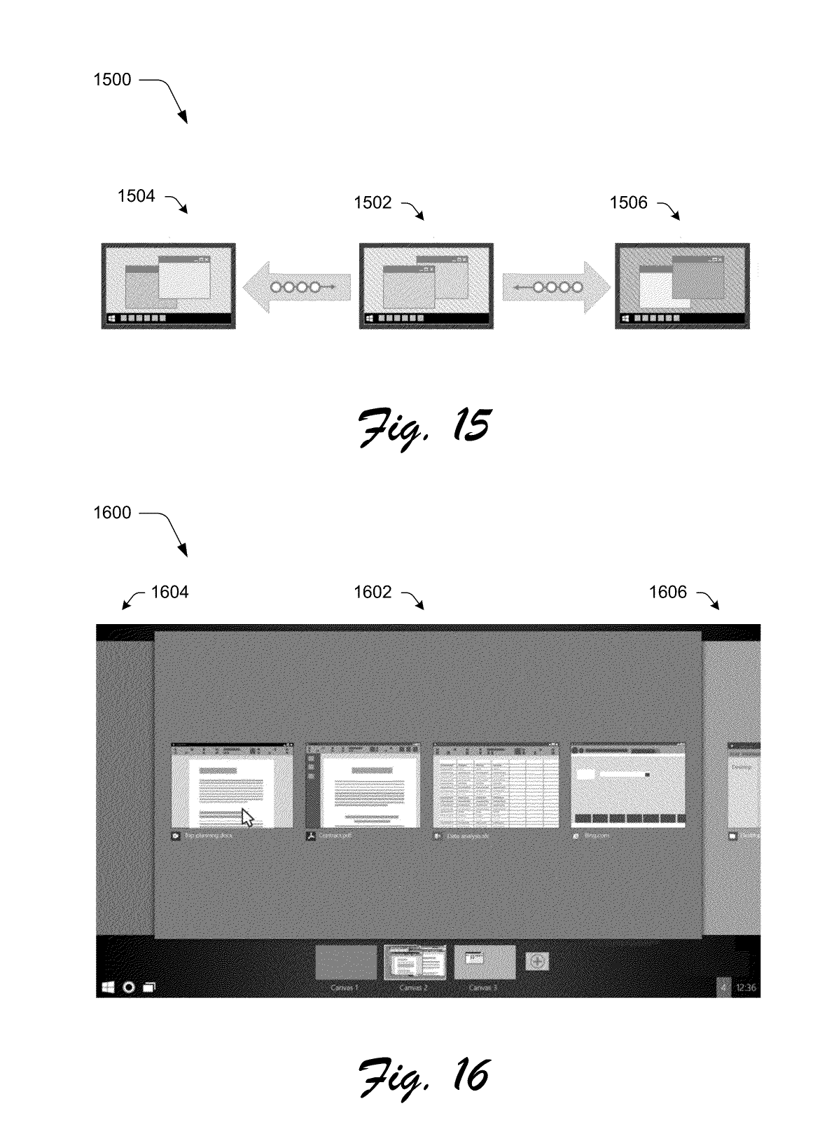

FIG. 15 depicts an example implementation 1500 of navigation between virtual desktops of an operating system. Users may navigate through virtual desktops 116 in variety of ways. As illustrated, for instance, a user may access a virtual desktop 1502 and make a gesture (e.g., a four finger swipe to the left) to access virtual desktop 1504 or a gesture (e.g., a four finger swipe to the right) to access virtual desktop 1506, e.g., using a touchscreen, trackpad, and so forth. Keyboard shortcuts and hotkeys may also be supported, such as to iteratively cycle through virtual desktop in defined sequential orders.

FIG. 16 is an illustration of an example implementation of an all-up user interface 1600 view that employs wings that support navigation between virtual desktops. The user interface 1600 include a primary portion 1602 and secondary portions 1604, 1606 that include slivers of virtual desktops.

Selection of the secondary portions 1604, 1606 causes the respective virtual desktops to be used to replace a current virtual desktop in the primary portion 1602 but does not cause actual navigation to those virtual desktops, e.g., unless selected when in the primary portion.

FIG. 17 depicts an example implementation 1700 showing menus 1702, 1704 usable to specify how applications are associated with virtual desktops. From a jump list on a taskbar, a user may choose whether or not an application 112 will be associated with each of the virtual desktops 116 as illustrated. In one or more implementations, this behavior is turned off by default and the windows of the application 112 are not associated with each of the virtual desktops 116 unless the application 112 specifies that associated windows are to be shown on each of the virtual desktops using one or more application programming interfaces. When this option is turned on by the user, then each of the windows of a respective application 112 are associated with each of the virtual desktops 116 of the operating system 110.

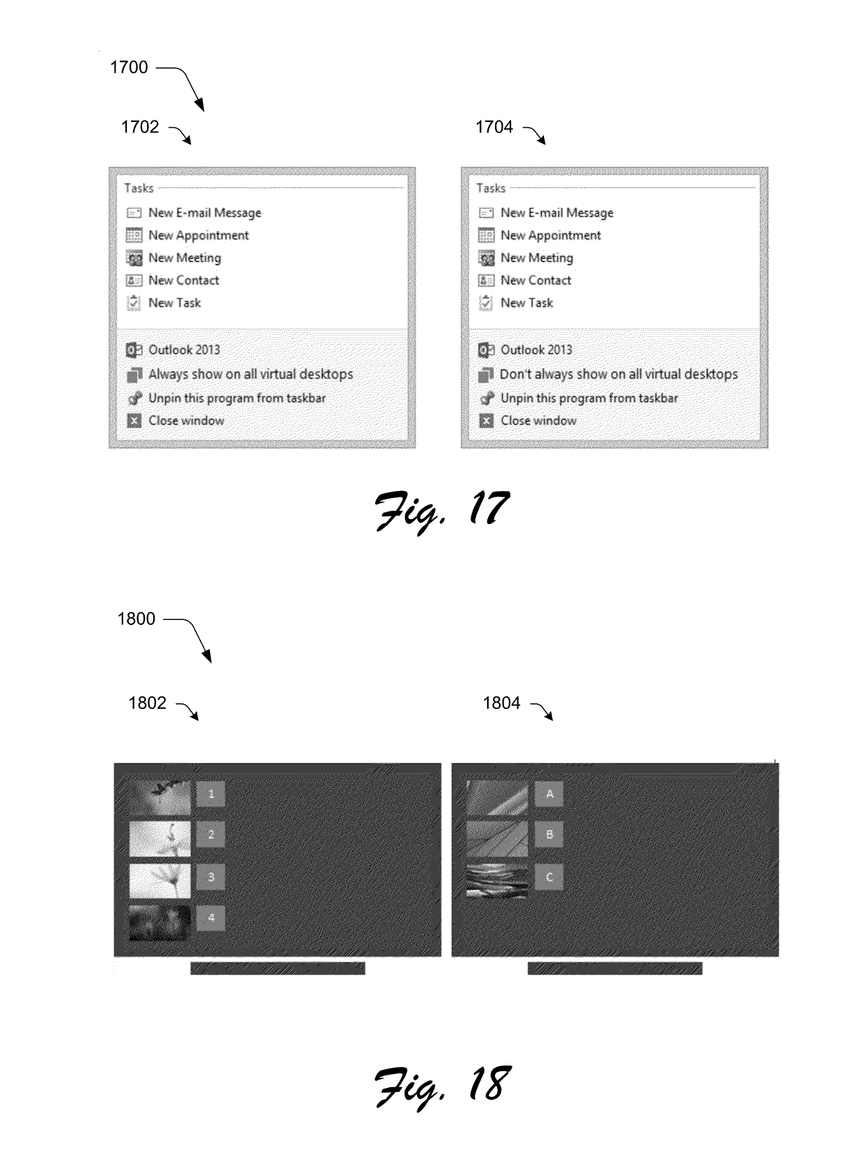

FIG. 18 depicts an example implementation 1800 of virtual desktops using a plurality of display devices. In this example, a plurality of display devices 1802, 1804 are employed by the operating system 110 of FIG. 1 to display a user interface. Each of the display devices 1802, 1804 has its own corresponding set of virtual desktops 116 that operate largely independent of other display devices. Accordingly, a user may have a different number of virtual desktops 116 on different display devices and may independently switch virtual desktops 116 on one display device 1802 without affecting another display device 1804 and vice versa.

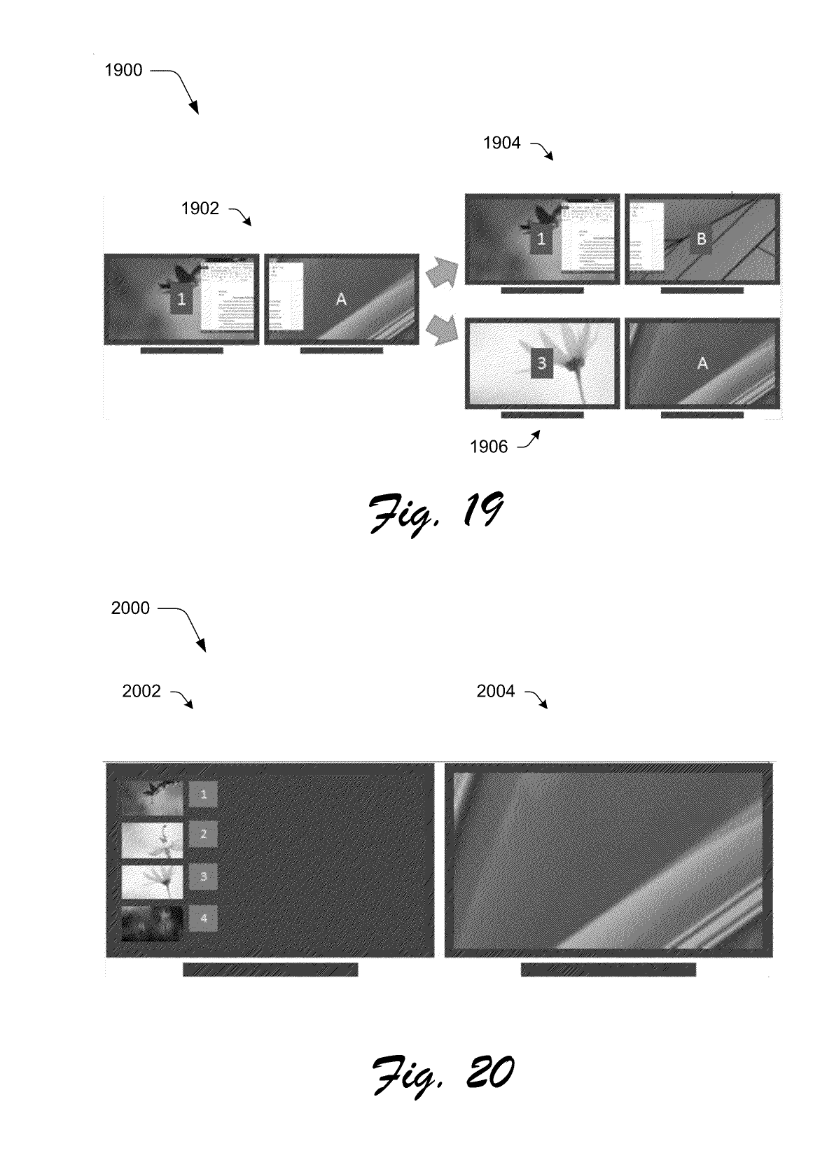

As shown in the example implementation 1900 of FIG. 19 at 1902, a window that straddles multiple display devices may be conceptually associated with the virtual desktop 116 on the display device that hosts a majority of a display area of the window. As long as the associated virtual desktop is displayed, the window may be visible across the display devices it spans as shown at 1904. If the associated virtual desktop is not displayed, the window is not visible on the display devices as shown at 1906. When a display device is disconnected from the computing device 102, virtual desktops including their associated windows on the disconnected display device may be preserved and appended to a list of virtual desktops on the primary display device. Other examples are also contemplated, an example of which is described as follows and shown in a corresponding figure.

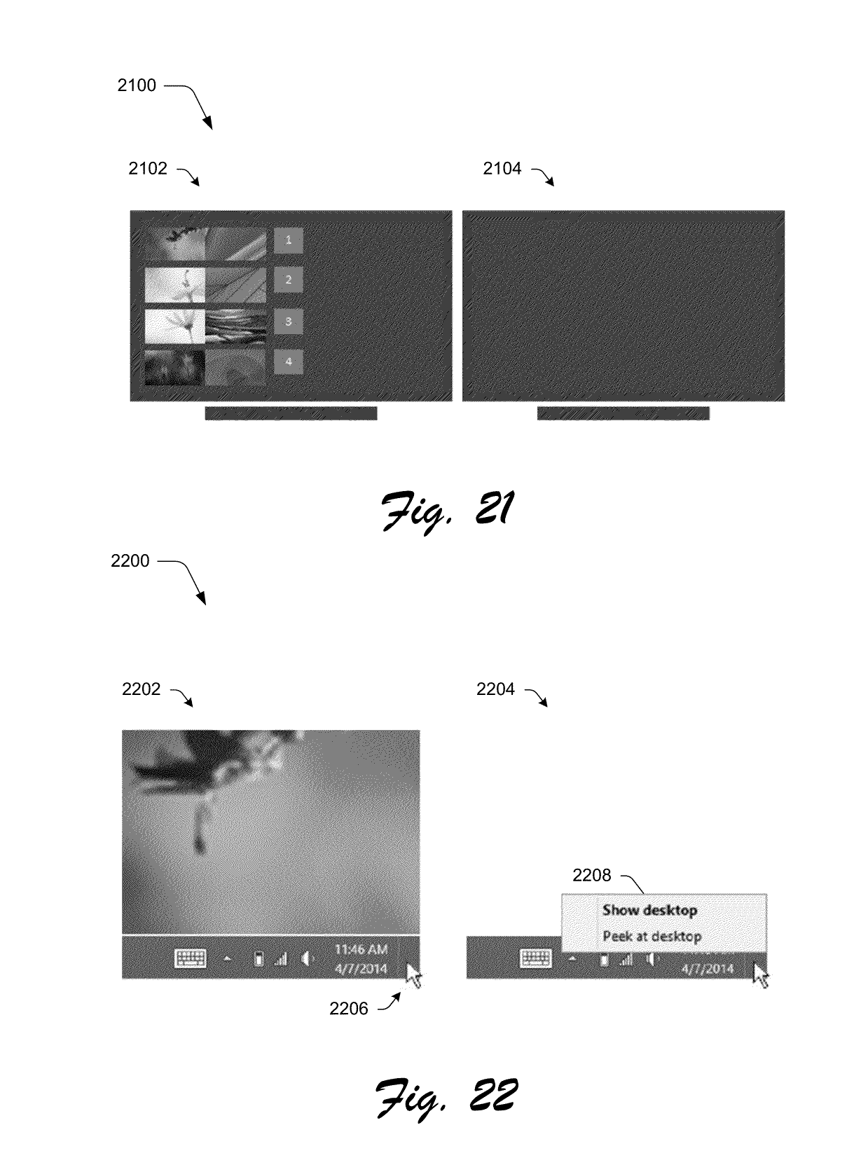

FIG. 20 depicts another example implementation 2000 of virtual desktops employed using a plurality of display devices 2002, 2004. In this example, a primary display device 2002 is solely authorized to navigate through virtual desktops 116 such that a secondary display device 2004 is limited to a single virtual desktop. The virtual desktop of the secondary display device 2004 may be the same as or different from the virtual desktop displayed by the primary display device 2002.

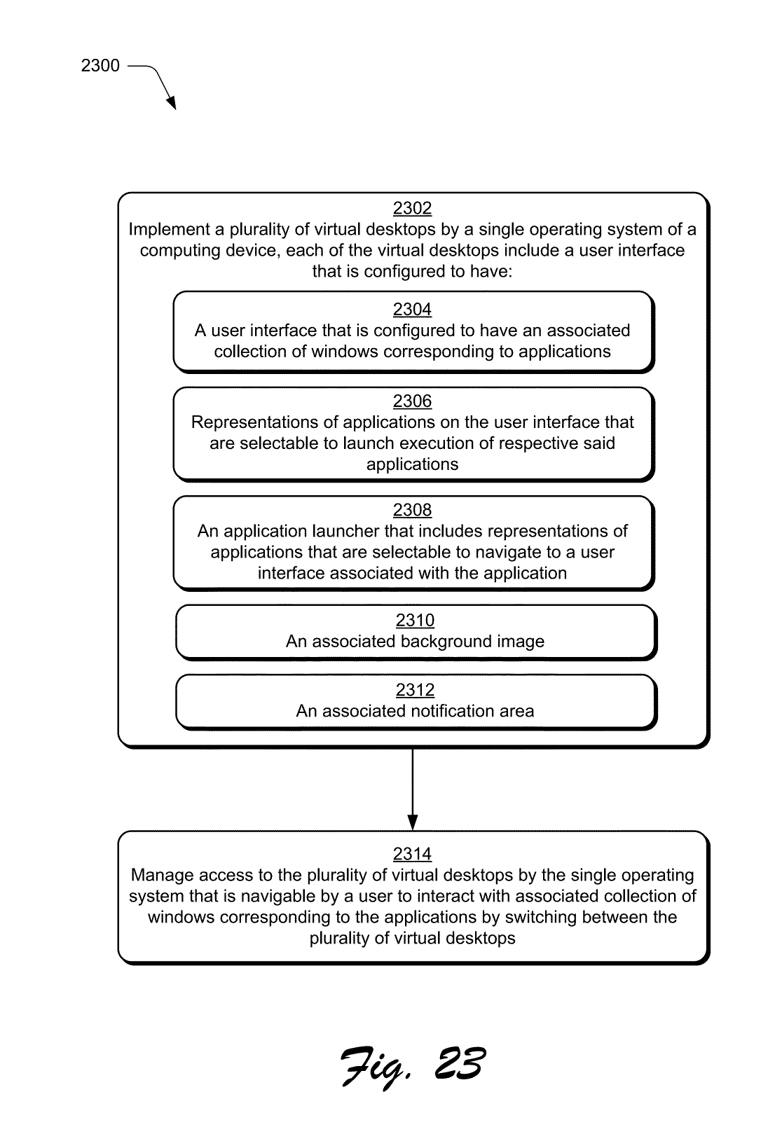

FIG. 21 depicts another example implementation 2100 of virtual desktops employed using a plurality of display devices 2102, 2104. In this example, a single virtual desktop extends across both display devices 2102, 2104. When a display device is disconnected from the computing device 102, windows on the disconnected display device may be forcefully moved to the remaining display device for each virtual desktop 116.

FIG. 22 depicts an example implementation 2200 of an option that is selectable by a user to show a virtual desktop. This example implementation 2200 is illustrated using first and second stages 2202, 2204. At the first stage 2202, a show desktop button 2206 is included by a notification area. A right-click of the show desktop button 2206 may cause output of a menu 2208 having options to show a desktop or peek at a desktop.

Selection of the show desktop option causes each of the windows shown in a current virtual desktop to be cloaked. On a second selection of the show desktop button, the windows that were just cloaked are un-cloaked such that the windows return to the same state, including relative z-order. A variety of other examples are also contemplated as further described above and in the following procedures.

Example Procedures

The following discussion describes operating system virtual desktop techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the figures described above.

Functionality, features, and concepts described in relation to the examples of FIGS. 1-22 may be employed in the context of the procedures described herein. Further, functionality, features, and concepts described in relation to different procedures below may be interchanged among the different procedures and are not limited to implementation in the context of an individual procedure. Moreover, blocks associated with different representative procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples.

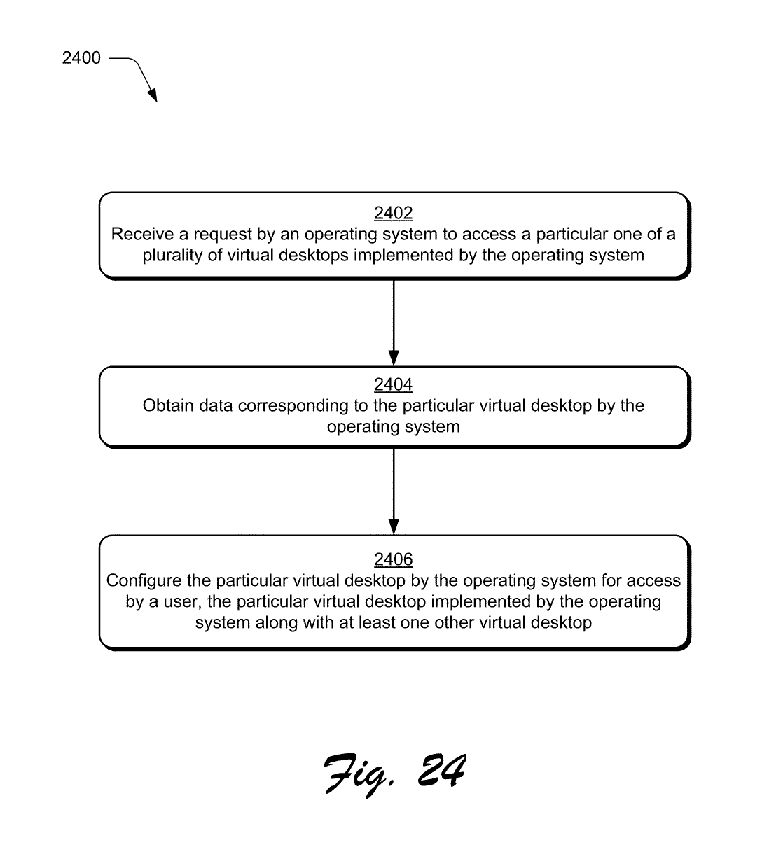

FIG. 23 depicts a procedure 2300 in an example implementation in which a plurality of virtual desktops are implemented by a single operating system. A plurality of virtual desktops are implemented by a single operating system of a computing device. Each of the virtual desktops includes a user interface that is configured to have a variety of different functionality (block 2302).

Examples of this functionality include a user interface that is configured to have an associated collection of windows corresponding to applications (block 2304) and as such each virtual desktop 116 may have a different collection of windows, one to another, associated with that desktop as shown for the work-related virtual desktop 202 and the leisure-related virtual desktop 204 of FIG. 2. The functionality may also include representations of applications on the user interface that are selectable to launch execution of respective applications (block 2306), such as icons, tiles, and so on.

Additionally, the functionality may include an application launcher that includes representations of application that are selectable to navigate to a user interface associated with the application (block 2308). As previously described, an application launcher may assume a variety of different forms, such as a root level of a file hierarchy, a taskbar, a start menu, a start screen, and so forth. Other examples of functionality includes an associated background image (block 2310) such as backgrounds 206, 208 and associated images and associated notification areas (block 2312) examples of which include notification areas 224, 226 used to output notifications.

Access to the plurality of virtual desktops is managed by the single operating system that is navigable by a user to interact with associated collections of windows corresponding to the applications by switching between the plurality of virtual desktops (block 2314). The switch may be performed responsive to a variety of different user input, such as a key combination, gesture, trackpad gesture, spoken utterance, selection of a button in a user interface, and so forth.

FIG. 24 depicts a procedure 2400 in an example implementation in which data is obtained to implement a virtual desktop by an operating system. A request is received by an operating system to access a particular one of a plurality of virtual desktops implemented by the operating system (block 2402). A user, for instance, may be exposed to a menu including a plurality of representations of recently accessed virtual desktops 116 and select a virtual desktop of interest. In another instance, a user may request a “readymade” virtual desktop as part of a subscription service, purchase at an online store hosted by a web service, and so on.

Data is obtained that corresponds to the particular virtual desktop by the operating system (block 2404). Continuing with the previous example, a user may request a previously utilized virtual desktop with which interaction was performed on another device. Accordingly, the operating system 110 may access a web service via a network to obtain data describing settings, configuration, and so on of that virtual desktop. The particular virtual desktop is then configured by the operating system for access by a user, the particular virtual desktop implemented by the operating system along with at least one other virtual desktop (block 2406). Thus, in this example the particular virtual desktop is added to another virtual desktop that was utilized to support user interaction in making the request. Other examples are also contemplated without departing from the spirit and scope thereof.

Example System and Device

FIG. 25 illustrates an example system generally at 2500 that includes an example computing device 2502 that is representative of one or more computing systems and/or devices that may implement the various techniques described herein. An example of this is illustrated through inclusion of the desktop manager module 114 and virtual desktops 116. The computing device 2502 may be, for example, a server of a service provider, a device associated with a client (e.g., a client device), an on-chip system, and/or any other suitable computing device or computing system.

The example computing device 2502 as illustrated includes a processing system 2504, one or more computer-readable media 2506, and one or more I/O interface 2508 that are communicatively coupled, one to another. Although not shown, the computing device 2502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 2504 is representative of functionality to perform one or more operations using hardware. Accordingly, the processing system 2504 is illustrated as including hardware element 2510 that may be configured as processors, functional blocks, and so forth. This may include implementation in hardware as an application specific integrated circuit or other logic device formed using one or more semiconductors. The hardware elements 2510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 2506 is illustrated as including memory/storage 2512. The memory/storage 2512 represents memory/storage capacity associated with one or more computer-readable media. The memory/storage component 2512 may include volatile media (such as random access memory (RAM)) and/or nonvolatile media (such as read only memory (ROM), Flash memory, optical disks, magnetic disks, and so forth). The memory/storage component 2512 may include fixed media (e.g., RAM, ROM, a fixed hard drive, and so on) as well as removable media (e.g., Flash memory, a removable hard drive, an optical disc, and so forth). The computer-readable media 2506 may be configured in a variety of other ways as further described below.

Input/output interface(s) 2508 are representative of functionality to allow a user to enter commands and information to computing device 2502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 2502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 2502. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 2502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 2510 and computer-readable media 2506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 2510. The computing device 2502 may be configured to implement particular instructions and/or functions corresponding to the software and/or hardware modules. Accordingly, implementation of a module that is executable by the computing device 2502 as software may be achieved at least partially in hardware, e.g., through use of computer-readable storage media and/or hardware elements 2510 of the processing system 2504. The instructions and/or functions may be executable/operable by one or more articles of manufacture (for example, one or more computing devices 2502 and/or processing systems 2504) to implement techniques, modules, and examples described herein.

As further illustrated in FIG. 25, the example system 2500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 2500, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 2502 may assume a variety of different configurations, such as for computer 2514, mobile 2516, and television 2518 uses. Each of these configurations includes devices that may have generally different constructs and capabilities, and thus the computing device 2502 may be configured according to one or more of the different device classes. For instance, the computing device 2502 may be implemented as the computer 2514 class of a device that includes a personal computer, desktop computer, a multi-screen computer, laptop computer, netbook, and so on.

The computing device 2502 may also be implemented as the mobile 2516 class of device that includes mobile devices, such as a mobile phone, portable music player, portable gaming device, a tablet computer, a multi-screen computer, and so on. The computing device 2502 may also be implemented as the television 2518 class of device that includes devices having or connected to generally larger screens in casual viewing environments. These devices include televisions, set-top boxes, gaming consoles, and so on.

The techniques described herein may be supported by these various configurations of the computing device 2502 and are not limited to the specific examples of the techniques described herein. This functionality may also be implemented all or in part through use of a distributed system, such as over a “cloud” 2520 via a platform 2522 as described below.

The cloud 2520 includes and/or is representative of a platform 2522 for resources 2524. The platform 2522 abstracts underlying functionality of hardware (e.g., servers) and software resources of the cloud 2520. The resources 2524 may include applications and/or data that can be utilized while computer processing is executed on servers that are remote from the computing device 2502. Resources 2524 can also include services provided over the Internet and/or through a subscriber network, such as a cellular or Wi-Fi network.

The platform 2522 may abstract resources and functions to connect the computing device 2502 with other computing devices. The platform 2522 may also serve to abstract scaling of resources to provide a corresponding level of scale to encountered demand for the resources 2524 that are implemented via the platform 2522. Accordingly, in an interconnected device embodiment, implementation of functionality described herein may be distributed throughout the system 2500. For example, the functionality may be implemented in part on the computing device 2502 as well as via the platform 2522 that abstracts the functionality of the cloud 2520.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method comprising:
implementing a plurality of virtual desktops by a single operating system of a computing device, each said virtual desktop including a user interface that is configured to have an associated collection of windows corresponding to applications; and
managing access to the plurality of virtual desktops by the single operating system that is navigable by a user to interact with associated collection of representations of applications and windows corresponding to the applications by switching between the plurality of virtual desktops.

2. A method as described in claim 1, wherein the plurality of virtual desktops are accessible via a single user login.

3. A method as described in claim 1, wherein:
an associated collection of windows corresponding to applications of a first said virtual desktop is configured to be different than an associated collection of windows corresponding to applications of a second said virtual desktop; or
said windows corresponding to applications are assigned based on one or more user inputs.

4. A method as described in claim 1, wherein each said virtual desktop is configured to include representations of applications on the user interface that are selectable to launch execution of respective said applications.

5. A method as described in claim 1, wherein each said virtual desktop is configured to have associated therewith an application launcher that includes representations of applications that are selectable to navigate to a user interface associated with the application.

6. A method as described in claim 1, wherein the application launcher is configured as a start screen, a start menu, or a taskbar.

7. A method as described in claim 1, wherein at least one said virtual desktop is obtained remotely via a network.

8. A method as described in claim 1, wherein each of the plurality of virtual desktops is configured to have an associated background image.

9. A method as described in claim 8, wherein:
the associated background image is assigned to a respective said virtual desktop by the operating system automatically and without user intervention; or
the associated background image is assigned to a respective said virtual desktop by the operating system automatically and without user intervention and is configured to be overridden by a user through receipt of one or more inputs.

10. A method as described in claim 1, wherein each of the plurality of virtual desktops is configured to have an associated notification area.

11. A method as described in claim 1, wherein the implementing includes outputting an option, selection of which causes creation of at least one said virtual desktop to be added by the operating system to one or more existing said virtual desktops of the operating system.

12. A method as described in claim 1, wherein at least one said virtual desktop is configured as a protected virtual desktop:
having a security boundary such that sharing of data within the protected virtual desktop with other said virtual desktops is restricted; or
such that execution of particular applications or inclusion of particular data is limited to the protected virtual desktop.

13. A method as described in claim 1, wherein the managing includes:
moving at least one said window of a respective said application from a first said virtual desktop to a second said virtual desktop responsive to a user input; or
making at least one said window of a respective said application available via each of the plurality of virtual desktop responsive to a user input.

14. An apparatus comprising:
a processing system; and
memory configured to maintain an operating system that is executable by the processing system to perform operations including outputting an application launcher for display in a user interface, the application launcher including representations of applications that are selectable for execution in a respective one of a plurality of virtual desktops of the operating system in which display of the representation of the applications as part of the application launcher includes use of a visual characteristic indicative of a corresponding one of the plurality of virtual desktops with which execution of a respective said application is associated.

15. An apparatus as described in claim 14, wherein the application launcher is configured as a start screen a start menu, or a taskbar.

16. An apparatus as described in claim 14, wherein the visual characteristic is a common color, a shade, or at least a portion of a background of the corresponding said virtual desktop as part of the display of the representation.

17. An apparatus as described in claim 14, wherein the application launcher is configured to include:
at least one said representation of a corresponding said application in the application launcher responsive to launching execution of the corresponding said application; and
one or more said representations of corresponding said applications responsive to an input received from a user by the operating system indicating that the corresponding said applications are to be included as part of the application launcher.

18. A system comprising:
one or more modules implemented at least partially in hardware, the one or more modules configured to perform operations comprising:
receiving a request by an operating system to access a particular one of a plurality of virtual desktops implemented by the operating system;
obtaining data corresponding to the particular virtual desktop by the operating system; and
configuring the particular virtual desktop by the operating system for access by a user, the particular virtual desktop implemented by the operating system along with at least one other said virtual desktop.

19. A system as described in claim 18, wherein the obtaining is performed by requesting the data via a network that is accessible to the operating system.

20. A system as described in claim 18, wherein:
the particular said virtual desktop was previously implemented by the operating system;
the request includes selection of a corresponding one of a plurality of representations of respective said virtual desktops; or
the particular said virtual desktop is selected through interaction with an online store of a web service or as part of a subscription.
